(19) United States
(12) Patent Application Publication
(10) Pub. No.: US 2009/0105434 A1
(43) Pub. Date: Apr. 23, 2009

(54) PROCESS FOR THE PREPARATION OF PROPYLENE

(76) Inventors: Leslie Andrew Chewter, Amsterdam (NL); Michiel Johannes Franciscus Maria Verhaak, Amsterdam (NL); Jeroen Van Westrenen, Amsterdam (NL)

Correspondence Address: SHELL OIL COMPANY, P O BOX 2463, HOUSTON, TX, 772522463, US

(21) Appl. No.: 12/301,149

(22) PCT Filed: May 16, 2007
(86) PCT No.: PCT/EP07/54756

§ 371 Date: Dec. 9, 2008

(30) Foreign Application Priority Data
May 19, 2006 (EP) 06114288.1

(51) Int. Cl. C08F 4/18

(52) U.S. Cl. 526/194

(57) ABSTRACT

Process for the preparation of propylene, wherein a diluted olefinic hydrocarbon feed, comprising in the range of 1 to 99 vol % of olefinic hydrocarbon feed and 1-99 vol % of one or more diluents, is contacted with a solid zeolite catalyst at a Gas Hourly Space Velocity, as measured at standard temperature and pressure of 23° C. and 1 bar, of at least 15,000 ml diluted olefinic hydrocarbon feed/gram zeolite catalyst/hour.

### TECHNICAL FIELD OF THE INVENTION

This invention relates to a process for the preparation of propylene from an olefinic hydrocarbon feed.

### BACKGROUND OF THE INVENTION

Processes for the preparation of propylene from an olefinic hydrocarbon feed are well known in the art.

For example, WO-A-99/057226 describes a method for converting a hydrocarbon feedstock to propylene by contacting the hydrocarbon feedstock under cracking conditions with a catalyst selected from the group consisting of medium pore zeolites having a silica to alumina ratio in excess of 200. In passing it is stated that the feed should contain from at least 10 wt % to about 70 wt % olefins and may also include naphthenes and aromatics. Further, in passing, weight hourly space velocities in the range of about 0.1 hr⁻¹ to about 1,000 hr⁻¹ are described. In example 1 of WO-A-99/057226, a 50/50 blend of n-hexane/n-hexene was contacted at 575° C. with a ZSM-48 catalyst and a ZSM-22 catalyst at a weight hourly space velocity of 12 hr⁻¹. The product included propylene and butylene in a weight ratio of propylene to butylene of about 8.7 and propylene and ethylene in a weight ratio of propylene to ethylene of about 13.6. However, less than 50% of the feedstock was actually converted.

WO-A-2001/034730 describes a process to produce propylene from a hydrocarbon feed stream. In passing, weight hourly space velocities in the range of about 0.1 hr⁻¹ to about 300 hr⁻¹ are described. In comparative example 1, a blend of pentene, hexene, heptene, octenen, nonene, decene, pentane, hexane, heptane octane, nonane, benzene, toluene and xylene was cracked over a ZSM-5 zeolite at 50 hr-1 WHSV, 0.04 Mpa (about 0.4 bar) and 590° C. with a 0.2 steam/hydrocarbon ratio. The product included propylene and butylene in a weight ratio of propylene to butylene of about 1.6 and propylene and ethylene in a weight ratio of propylene to ethylene of about 4.2. A mere 40.1 wt % of the feedstock was actually converted. It would be desirable to have a process that would be able to convert a hydrocarbon feedstock with a high conversion primarily into propylene.

### SUMMARY OF THE INVENTION

It has now been surprisingly found that an olefinic hydrocarbon feed can be converted with high conversion primarily into propylene, when the olefinic hydrocarbon feed is diluted and contacted with a solid zeolite catalyst at an elevated gas hourly space velocity.

Accordingly, the present invention provides a process for the preparation of propylene, wherein a diluted olefinic hydrocarbon feed, comprising in the range of 1 to 99 vol % of olefinic hydrocarbon feed and 1-99 vol % of one or more diluents, is contacted with a solid zeolite catalyst at a Gas Hourly Space Velocity, as measured at standard temperature and pressure of 23° C. and 1 bar, of at least 15,000 ml diluted olefinic hydrocarbon feed/gram zeolite catalyst/hour.

With the process according to the invention propylene can be prepared in a high selectivity with a high conversion.

### DETAILED DESCRIPTION OF THE INVENTION

By a hydrocarbon is understood a compound comprising both carbon atoms as well as hydrogen atoms. By an olefinic hydrocarbon feed is understood a feed containing one or more olefinic hydrocarbons (also referred to herein as olefins). By a diluted olefinic hydrocarbon feed is understood an olefinic hydrocarbon feed as described herein diluted with a diluent.

The olefinic hydrocarbon feed can contain one olefin or a mixture of olefins. Preferably the olefinic hydrocarbon feed contains a mixture of olefins. Apart from olefins, the olefinic hydrocarbon feed may contain other hydrocarbon compounds, such as for example paraffinic, alkylaromatic, aromatic compounds or mixtures thereof. Preferably the olefinic hydrocarbon feed comprises more than 30 wt %, more preferably more than 50 wt %, still more preferably more than 80 wt % and most preferably in the range from 90 to 100 wt % of olefin(s)based on the total weight of hydrocarbons. An especially preferred olefinic hydrocarbon feed consists essentially of olefin(s).

Any non-olefinic compounds in the olefinic hydrocarbon feed are preferably paraffinic compounds. Such paraffinic compounds are preferably present in an amount of less than 10 wt %, more preferably in an amount in the range from 0 to 5 wt %, still more preferably in the range from 0 to 1 wt % and most preferably in an amount of less than 0.5 wt %, based on the total weight of hydrocarbons. If the olefinic hydrocarbon feed comprises both olefinic as well as paraffinic compounds, such olefinic and paraffinic compounds preferably comprise 5 and/or 6 carbon atoms, and more preferably such olefinic and paraffinic compounds are C₆-paraffins and C₆-olefins, preferably hexanes and hexenes.

By an olefin is understood an organic compound containing at least two carbon atoms connected by a double bond. A wide range of olefins can be used. The olefin can be a mono-olefin, having one double bond, or a poly-olefin, having two or more double bonds. Preferably olefins present in the olefinic hydrocarbon feed are mono-olefins.

The olefin(s) can be linear, branched or cyclic. Preferably olefins present in the olefinic hydrocarbon feed are linear or branched olefins. Preferred olefins have in the range from 2 to 12, preferably in the range from 3 to 10, and more preferably in the range from 4 to 8 carbon atoms. Even more preferred olefins are C₅ and C₆ olefins or mixtures thereof. Most preferred olefins are C₆ olefins.

Examples of suitable olefins that may be contained in the olefinic hydrocarbon feed include ethene, propene, 1-butene, 2-butene, iso-butene (2-methyl-1-propene), 1-pentene, 2-pentene, 2-methyl-1-butene, 2-methyl-2-butene, 3-methyl-1-butene, 1-hexene, 2-hexene, 3-hexene, 2-methyl-1-pentene, 2-methyl-2-pentene, 3-methyl-1-pentene, 3-methyl-2-pentene, 4-methyl-1-pentene, 4-methyl-2-pentene, 2,3-dimethyl-1-butene, 2,3-dimethyl-2-butene, 3,3-dimethyl-1-butene, heptenes, octenes, nonenes and decenes. Preferred olefins are pentenes, hexenes and mixtures thereof. Most preferred are hexenes.

The olefinic hydrocarbon feed preferably comprises at least 30% w/w C₅ and/or C₆ olefins, more preferably at least 50% w/w C₅ and/or C₆ olefins and still more preferably in the range from 80% to 100% w/w C₅ and/or C₆ olefins, based on the total weight of hydrocarbons. In a further preferred embodiment the hydrocarbon feed consists essentially of C₅ and/or C₆ olefins.

In a further preferred embodiment the olefinic hydrocarbon feed essentially consists of olefins and preferably comprises at least 30% w/w C₆ olefins, more preferably at least 50% w/w C₆ olefins and still more preferably at least 80% w/w C₆ olefins, based on the total weight of hydrocarbons.

More preferably the olefinic hydrocarbon feed consists essentially of C₆ olefins.

The diluted olefinic hydrocarbon feed contains both olefinic hydrocarbon feed and diluent. Preferably the olefinic hydrocarbon feed comprises in the range of 1 to 90 vol % of olefinic hydrocarbon feed and 10 to 99 vol % of one or more diluents, more preferably in the range of 2 to 80 vol % of olefinic hydrocarbon feed and 20 to 98 vol % of one or more diluents, still more preferably in the range of 2.5 to 70 vol % of olefinic hydrocarbon feed and 30 to 97.5 vol % of one or more diluents, based on the total volume of the feed. Although other components might be present in the diluted olefinic hydrocarbon feed, the diluted olefinic hydrocarbon feed preferably consists of only olefinic hydrocarbon feed and one or more diluents.

Any diluent known by the skilled person to be suitable for such purpose can be used. Such diluent can for example be a paraffinic compound or mixture of compounds. Preferably, however, the diluent is an inert gas. More preferably, the diluent is chosen from the group of inert gases such as argon, nitrogen and steam. Of these, steam is the most preferred diluent. For example, the oxygenate feed and/or olefinic co-feed can be diluted with steam, for example in the range from 0.01 to 10 kg steam per kg feed.

The olefinic hydrocarbon feed and the diluent can be mixed with each other in a separate mixing nozzle, possibly whilst using mixing devices to enhance the mixing process. Or, if desirable, a product from another process containing olefins and a diluent can be used as diluted olefinic hydrocarbon feed.

The diluted olefinic hydrocarbon feed is contacted with a solid zeolite catalyst.

By a zeolite catalyst is understood a catalyst containing a zeolite.

Preferably, the zeolite is a zeolite comprising a 10-membered ring channel. More preferably this zeolite is a one-dimensional zeolite having 10-membered ring channels. A one-dimensional zeolite having 10-membered ring channels is understood to be a zeolite having only 10-membered ring channels in one direction which are not intersected by other 8, 10 or 12-membered ring channels from another direction.

One suitable zeolite is a zeolite of the MFI-type (for example ZSM-5). Preferably, however, the zeolite is selected from the group of TON-type (for example ZSM-22), MTT-type (for example ZSM-23), STF-type (for example SSZ-35), SFF-type (for example SSZ-44) and EU-2-type/ZSM-48 zeolites.

The preferred zeolites used in the present invention are distinct from zeolites having small pore 8-ring channels or zeolites having large pore 12-ring channels.

MTT-type catalysts are more particularly described in e.g. U.S. Pat. No. 4,076,842. For purposes of the present invention, MTT is considered to include its isotypes, e.g., ZSM-23, EU-13, ISI-4 and KZ-1.

TON-type zeolites are more particularly described in e.g. U.S. Pat. No. 4,556,477. For purposes of the present invention, TON is considered to include its isotypes, e.g., ZSM-22, Theta-1, ISI-1, KZ-2 and NU-10.

EU-2-type zeolites are more particularly described in e.g. U.S. Pat. No. 4,397,827. For purposes of the present invention, EU-2 is considered to include its isotypes, e.g., ZSM-48.

In a preferred embodiment, a zeolite of the MTT-type or TON-type is used in the process of the invention.

In an even more preferred embodiment a zeolite of the MTT-type, such as ZSM-23, is used.

Preferably a zeolite in the hydrogen form is used, e.g., HZSM-22, HZSM-23, HZSM-48. Preferably at least 50% w/w, more preferably at least 90% w/w, still more preferably at least 95% w/w and most preferably 100% of the total amount of zeolite used is zeolite in the hydrogen form. When the zeolites are prepared in the presence of organic cations the zeolite may be activated by heating in an inert or oxidative atmosphere to remove the organic cations, for example, by heating at a temperature over 500° C. for 1 hour or more. The hydrogen form can then be obtained by an ion exchange procedure with ammonium salts followed by another heat treatment, for example in an inert or oxidative atmosphere at a temperature over 500° C. for 1 hour or more. The zeolites obtained after ion exchange with ammonium salts are also referred to as being in the ammonium form.

Preferably the zeolite has a silica to alumina ratio (SAR) in the range from 1 to 500. More preferably the zeolite has a SAR in the range from 10 to 200, still more preferably the zeolite has a SAR in the range from 10 to 150.

The zeolite can be used as such or in combination with a so-called binder material. If no binder material is used the zeolite is referred to as zeolite catalyst. If a binder is used the zeolite in combination with the binder material is referred to as zeolite catalyst.

It is desirable to provide a zeolite catalyst having good mechanical strength, because in an industrial environment the catalyst is often subjected to rough handling which tends to break down the catalyst into powder-like material. The later causes problems in the processing. Preferably the zeolite is therefore incorporated in a binder material. Examples of suitable binder materials include active and inactive materials and synthetic or naturally occurring zeolites as well as inorganic materials such as clays, silica, alumina, aluminosilicate. For present purposes, inactive materials of a low acidity, such as silica, are preferred because they may prevent unwanted side reactions which may take place in case a more acidic material, such as alumina is used. Preferably the catalyst used in the process of the present invention comprises, in addition to the zeolite, 2 to 90 wt %, preferably 10 to 85 wt % of a binder material.

The process of the present invention can be carried out in a batch, continuous, semi-batch or semi-continuous manner using conventional reactor systems such as fixed bed, moving bed, fluidized bed and the like. As a reactor any reactor known to the skilled person to be suitable for catalytic cracking can be used.

Conventional catalyst regeneration techniques can be employed. The catalyst used in the process of the present invention can have any shape known to the skilled person to be suitable for this purpose, for example the catalyst can be present in the form of catalyst tablets, rings, extrudates, etc. extruded catalysts can be applied in various shapes, such as, cylinders and trilobes. If desired, spent catalyst can be regenerated and recycled to the process of the invention.

Preferably the hydrocarbon feed is contacted with the zeolite at a temperature in the range from 300 to 650° C. to effect cracking of the hydrocarbon feed. By cracking of the hydrocarbon feed is understood the effective cracking hydrocarbons into smaller hydrocarbons. More preferably the hydrocarbon feed is contacted with the zeolite catalyst at a temperature in the range from 400° C. to 600° C., and still more preferably in the range from 450° C. to 550° C.

The pressure can vary widely, preferably a pressure in the range from 1 to 5 bar is applied, more preferably a pressure in the range of 1 to 3 bar is applied. The partial pressure of the olefinic hydrocarbon feed or any olefinic component therein can be calculated by multiplying the pressure applied with the vol %, that is if the volume percent is for example 5 vol % than the pressure is multiplied by ( 5/100), i.e. 0.05.

The Gas Hourly Space Velocity (GHSV), as measured at standard temperature and pressure (STP) of 23° C. and 1 bar, for such a process can vary over a wide range, starting from e.g. 2,000 ml/gram zeolite catalyst/hour or 3,000 ml/gram zeolite catalyst/hour. In the process of the invention, however, it has been found advantageous to use a Gas Hourly Space Velocity (GHSV) of at least 15,000 ml, preferably at least 25,000 ml, and more preferably at least 60,000 ml diluted olefinic hydrocarbon feed/gram zeolite catalyst/hour under standard conditions (STP) of 23° C. and 1 bar. More preferred is a Gas Hourly Space Velocity (GHSV) of at least 100,000 ml, more preferably at least 120,000 ml diluted olefinic hydrocarbon feed/gram zeolite catalyst/hour under standard conditions (STP) of 23° C. and 1 bar. Although there is no maximum, an upper limit may be determined by the dimensions of the equipment available. For practical purposes the GHSV is preferably at most 1,000,000 ml/gram zeolite catalyst/hour, more preferably at most 500,000 ml/gram zeolite catalyst/hour.

A Gas Hourly Space Velocity (GHSV) in the range from 120,000 ml to 360,000 ml diluted olefinic hydrocarbon feed/gram zeolite catalyst/hour under standard conditions (STP) of 23° C. and 1 bar is especially preferred.

In another advantageous embodiment, a Gas Hourly Space Velocity (GHSV) of at least 15,000 ml, preferably at least 25,000 ml, still more preferably at least 60,000 ml, and most preferably at least 120,000 ml diluted olefinic hydrocarbon feed/gram zeolite/hour under standard conditions (STP) of 23° C. and 1 bar is used. If the catalyst comprises both a zeolite and a binder, such GHSV based on gram zeolite/hour is calculated on the grams of zeolite only.

Gas Hourly Space Velocity is measured at a, within this specification defined as, standard temperature of 23° C. and a standard pressure of 1 bar (STP). By means of the ideal gas law (i.e. pressure times volume divided by temperature is constant), the Gas Hourly Space Velocity within any reactor can be calculated.

With the process according to the invention primarily propylene can be prepared with a high conversion.

A product stream of propylene can be separated from the reaction product by any method known to the person skilled in the art. Preferably such a separation is carried out in one or more distillation columns.

Depending on the hydrocarbon feed used, the reaction product can further contain unreacted C₅ and/or C₆ olefins. Such unreacted olefins are preferably recycled.

The process of the invention will herein below be illustrated by a number of non-limiting examples.

### EXAMPLE 1

In this example 1-hexene was reacted over TON and MTT type zeolites at two space velocities. The silica-to-alumina ratio were 102 and 48 for TON and MTT, respectively. A sample of zeolite powder was pressed into tablets and the tablets were broken into pieces and sieved. For catalytic testing, the sieve fraction of 40-60 mesh has been used. A quartz reactor tube of 3 mm internal diameter was loaded with either 50 or 200 mg of this sieve fraction. Prior to reaction, the fresh catalyst in its ammonium-form was treated with flowing argon at 550° C. for 2 hours. Next, the catalyst was cooled in argon to the reaction temperature and a mixture consisting of 2.6 vol. % 1-hexene and 2 vol. % of water in Argon, was passed over the catalyst at atmospheric pressure (1 bar) at a flow rates of 50 ml/min (200 mg catalyst) and 100 ml/min (50 mg catalyst). Gas hourly space velocities (GHSV) are 15,000 and 120,000 ml/gram/hr, respectively, based on total gas flow. All Gas Hourly Space Velocities are measured at standard temperature and pressure (STP), i.e. at 23° C. and 1 bar. Weight hourly space velocities (WHSV) are 1.5 and 11.7 gram hexene/gram catalyst/hr, based on hexene mass flow. Periodically, the effluent from the reactor was analyzed by gas chromatography (GC) to determine the product composition. The composition has been calculated on a weight basis. The following table (Table 1) lists reaction parameters together with the compositional data, as determined by GC:

TABLE 1

| Zeolite | MTT | TON | MTT | TON |
|---|---|---|---|---|
| GHSV STP | 120,000 | 120,000 | 15,000 | 15,000 |
| (ml/gram/hr − 1) | | | | |
| WHSV | 11.7 | 11.7 | 1.5 | 1.5 |
| (gram/gram/hr − 1) | | | | |
| Temperature ° C. | 500° C. | 500° C. | 500° C. | 500° C. |
| 1-hexene conversion, % | ~100 | ~100 | ~100 | ~100 |
| Ethylene, wt. % | 2.1 | 2.3 | 5.1 | 5.3 |
| Propylene, wt. % | 93.3 | 92.5 | 84.2 | 83.3 |
| Butene isomers, wt. % | 4.1 | 4.5 | 8.8 | 9.2 |
| Pentene isomers, wt. % | 0.4 | 0.5 | 1.1 | 1.1 |
| Propylene to Ethylene | 44.4 | 40.2 | 16.5 | 15.7 |
| weight ratio | | | | |
| Propylene to Butene | 22.8 | 20.6 | 9.6 | 9.1 |
| weight ratio | | | | |

Selectivity (based on weight) is the same as feed composition, in wt. %, since conversion levels are ˜100%. The data show that increasing the space velocity (and thus decreasing the contact time) results in substantially higher propylene selectivity while the selectivities of ethylene, butenes and pentenes all go down.

### EXAMPLE 2

In this example 1-hexene was reacted over TON-type zeolites at 4 different gas hourly space velocities. The silica-to-alumina ratio of the TON-type zeolite was 102. A sample of zeolite powder was pressed into tablets and the tablets were broken into pieces and sieved. For catalytic testing, the sieve fraction of 40-60 mesh has been used. A quartz reactor tube of 3 mm internal diameter was loaded with either 25, 50, 100 or 200 mg of this sieve fraction. Prior to reaction, the fresh catalyst in its ammonium-form was treated with flowing argon at 600° C. for 2 hours. Next, the catalyst was cooled in argon to the reaction temperature and a mixture consisting of 2.6 vol. % 1-hexene and 2 vol. % of water in Argon was passed over the catalyst at atmospheric pressure (1 bar) at a flow rates of 50 ml/min (200 mg catalyst), 100 ml/min (100 mg or 50 mg catalyst) and 150 ml/min (25 mg catalyst). Gas hourly space velocities (GHSV) are 15,000, 60,000, 120,000 and 360,000 ml/gram/hr, respectively, based on total gas flow. All Gas Hourly Space Velocities are measured at standard temperature and pressure (STP), i.e. at 23° C. and 1 bar. Weight hourly space velocities (WHSV) are 1.5, 5.9, 11.7 and 35.1 gram hexene/gram catalyst/hr, based on hexene mass flow. Periodically, the effluent from the reactor was analyzed by gas chromatography (GC) to determine the product composition. The selectivity has been defined by the division of the mass of product i by the sum of the masses of all products. The following table (Table 2) lists reaction parameters together with the compositional data, as determined by GC:

TABLE 2

| Zeolite | TON | TON | TON | TON |
|---|---|---|---|---|
| GHSV STP | 360,000 | 120,000 | 60,000 | 15,000 |
| (ml/gram/hr − 1) | | | | |
| Temperature ° C. | 450° C. | 450° C. | 450° C. | 450° C. |
| 1-hexene conversion, % | 76 | 92 | 94 | 95 |
| Ethylene, wt. % | 1.8 | 2.1 | 2.8 | 5.3 |
| Propylene, wt. % | 90 | 90 | 89 | 80 |
| Butene isomers, wt. % | 4.8 | 5.1 | 6.4 | 10.0 |
| Pentene isomers, wt. % | 2.5 | 1.7 | 1.3 | nm* |
| Propylene to Ethylene | 50 | 42.9 | 31.8 | 15.1 |
| weight ratio | | | | |
| Propylene to Butene | 18.8 | 17.6 | 13.9 | 8 |
| weight ratio | | | | |

*nm = not measured

### EXAMPLE 3

In this example a mixture of 1-hexene and n-hexane was reacted over a MTT-type zeolite. The silica-to-alumina ratio of the MTT-type zeolite was 48. A sample of zeolite powder was pressed into tablets and the tablets were broken into pieces and sieved. For catalytic testing, the sieve fraction of 40-60 mesh has been used. The fresh catalyst in its ammonium-form was first treated in air at 600° C. for 4 hours. A quartz reactor tube of 3 mm internal diameter was loaded with 50 mg of catalyst. The reactor was heated in argon to the reaction temperature and a mixture consisting of 2.2 vol. % 1-hexene, 1.8 vol % n-hexane and 2 vol. % of water in Argon was passed over the catalyst at atmospheric pressure (1 bar) at a flow rates of 100 ml/min. Gas hourly space velocity (GHSV) is 120,000, based on total gas flow. All Gas Hourly Space Velocities are measured at standard temperature and pressure (STP), i.e. at 23° C. and 1 bar. Weight hourly space velocity (WHSV) is 18 gram(hexene+hexane)/gram catalyst/hr, based on combined (hexene+hexane) mass flow. Periodically, the effluent from the reactor was analyzed by gas chromatography (GC) to determine the product composition. The selectivity has been defined by the division of the mass of product i by the sum of the masses of all products. The following table (Table 3) lists reaction parameters together with the compositional data, as determined by GC:

TABLE 3

| Zeolite | MTT |
|---|---|
| GHSV STP (ml/gram/hr − 1) | 120,000 |
| Temperature ° C. | 525° C. |
| 1-hexene conversion, % | ~100 |
| hexane conversion, % | 14 |
| Ethylene, wt. % | 3.4 |
| Propylene, wt. % | 90 |
| Butene isomers, wt. % | 6.1 |
| Pentene isomers, wt. % | 0.8 |
| Propylene to Ethylene weight ratio | 26.5 |
| Propylene to Butene weight ratio | 14.8 |

1. A process for the preparation of propylene, wherein a diluted olefinic hydrocarbon feed, comprising in the range of 1 to 99 vol % of olefinic hydrocarbon feed and 1-99 vol % of one or more diluents, is contacted with a solid zeolite catalyst at a Gas Hourly Space Velocity, as measured at standard temperature and pressure of 23° C. and 1 bar, of at least 15,000 ml diluted olefinic hydrocarbon feed/gram zeolite catalyst/hour.

2. The process according to claim 1, wherein the catalyst comprises a one-dimensional zeolite having 10-membered ring channels.

3. The process according to claim 1, wherein the process is carried out at a temperature in the range from 300 to 600° C.

4. The process according to claim 1, wherein the olefinic hydrocarbon feed consists essentially of olefins.

5. The process according to claim 1, wherein the hydrocarbon feed consists essentially of C₅ and/or C₆ olefins.

6. The process according to claim 1, wherein the zeolite is chosen from the group consisting of TON-type, MTT-type and EU-2/ZSM-48 zeolites.

7. The process according to claim 1, wherein the zeolite is a MTT-type zeolite.

8. The process according to claim 1, wherein the zeolite is a TON-type zeolite.

9. The process according to claim 1 wherein at least part of any unconverted feed is recycled.

10. The process according to claim 1, wherein the Gas Hourly Space Velocity, as measured at standard temperature and pressure of 23° C. and 1 bar, lies in the range from 120,000 ml to 360,000 ml diluted olefinic hydrocarbon feed/gram zeolite catalyst/hour.
